(19) United States
(12) Patent Application Publication
(10) Pub. No.: US 2011/0084037 A1
(43) Pub. Date: Apr. 14, 2011

(54) Retail display assembly

(76) Inventor: Lisa L. Toone, St. Louis, MI (US)

(21) Appl. No.: 12/587,890

(22) Filed: Oct. 14, 2009

(51) Int. Cl. A47F 7/00; G09F 7/00

(52) U.S. Cl. 211/59.2; 40/584

(57) ABSTRACT

A retail display assembly adapted to be placed on a display tower is disclosed which comprises an upper portion having a first section having a top portion and a bottom portion with the bottom portion having a tab portion extending from the bottom portion and a second section having a top portion and a side flap and a lower portion having a first section having a top portion having a slot adapted for receiving the tab portion and a second section having a side flap.

### BACKGROUND

This disclosure relates to a retail merchandise display to promote the sale of merchandise, and more particularly, to a retail display assembly used in a display device such as a display tower or an alpha display.

Displays or display towers are used in commercial or retail establishments to display merchandise or advertisements for merchandise. Displays are also used for exhibits, booths, and trade shows. Typically these display towers are formed from rods or poles and shelves and are also known as alpha towers. Once assembled the display tower can hold cutouts, sheets, or panels formed from foam board, cardboard, or paper panels. However, such panels can be difficult to work with, may need to be replaced, and are difficult to easily secure to the display tower. In particular, if the panels have an advertisement printed on it and if the ad changes or a new advertisement is needed then new panels must be used. This requires that the old panels be removed from the display tower and new panels be printed and inserted into the display tower. Further, the manner in which the panels are held in place is cumbersome. Therefore, there is a need to provide a device that is used to easily assemble a display device that can fit on a display tower. It would also be advantageous to be able to easily remove the retail display assembly without the use of any equipment or tools.

The present disclosure is designed to obviate and overcome many of the disadvantages and shortcomings associated with presently available methods or constructions of fixing or securing cutouts, sheets, displays, or panels to a display tower. In particular, the present disclosure is a retail display assembly that is designed and constructed to be secured or attached to a display tower with the retail display assembly also being capable of being easily disassembled or removed from the display tower. Moreover, the retail display assembly of the present disclosure may be easily positioned on the display tower for proper alignment of the retail display assembly and for proper visual display of any advertisement printed on the retail display assembly.

### SUMMARY

In one form of the present disclosure, a retail display assembly adapted to be placed on a display tower comprises an upper portion having a first section having a top portion and a bottom portion with the bottom portion having a tab portion extending from the bottom portion and a second section having a top portion and a side flap and a lower portion having a first section having a top portion having a slot adapted for receiving the tab portion and a second section having a side flap.

In another form of the present disclosure, a retail display assembly retail display assembly adapted to be placed on a display tower comprises a pair of upper portions with each upper portion having a first section having a top portion and a bottom portion with the bottom portion having a tab portion extending from the bottom portion and a second section having a top portion and a side flap and a pair of lower portions with each lower portion having a first section having a top portion having a slot adapted for receiving the tab portion and a second section having a side flap.

In yet another form of the present disclosure, a retail display assembly is disclosed that comprises a left side upper portion having a first section having a top portion, a bottom portion with the bottom portion having a tab portion extending from the bottom portion, and a side flap, and a right side upper portion having a side flap and a lower portion having a first section having a top portion having a slot adapted for receiving the tab portion and a second section having a side flap.

In light of the foregoing comments, it will be recognized that a principal object of the present disclosure is to provide a retail display assembly for a display device or tower.

A further object of the present disclosure is to provide a retail display assembly which is of simple construction and design, is inexpensive, and which can be easily employed with highly reliable results.

Another object of the present disclosure is to provide a retail display assembly that is easy to use and may be easily positioned on a display device.

A still further object of the present disclosure is to provide a retail display assembly that can be secured in place and released from a display device.

A further object of the present disclosure is to provide a retail display assembly that may be used to prepare and construct a display.

Another object of the present disclosure is to provide a retail display assembly that may be easily removed from a display tower once the display is no longer needed.

Yet another object of the present disclosure is to provide a retail display assembly that may be easily manufactured and may be disposable.

These and other objects and advantages of the present disclosure will become apparent after considering the following detailed specification in conjunction with the accompanying drawings, wherein:

### BRIEF DESCRIPTION OF THE DRAWINGS

FIG. 1 is a perspective view of an embodiment of a retail display assembly constructed according to the present disclosure;

FIG. 2 is a front perspective view of an upper portion of the retail display assembly;

FIG. 3 is a front perspective view of a lower portion of the retail display assembly;

FIG. 4 is a perspective view of a fastening device used to connect the retail display assembly;

FIG. 5 is a partial perspective view of a lower portion of the retail display assembly being placed over a display device;

FIG. 6 is a perspective view of an upper portion being mated with a lower portion;

FIG. 7 is a front perspective view of another embodiment of an upper portion of the retail display assembly;

FIG. 8 is a front perspective view of another embodiment of an upper portion of the retail display assembly;

FIG. 9 is a perspective view of another embodiment of a retail display assembly constructed according to the present disclosure;

FIG. 10 is a front perspective view of an upper portion of the retail display assembly shown in FIG. 9; and

FIG. 11 is a perspective view of another embodiment of a retail display assembly constructed according to the present disclosure.

### DETAILED DESCRIPTION OF THE EMBODIMENTS

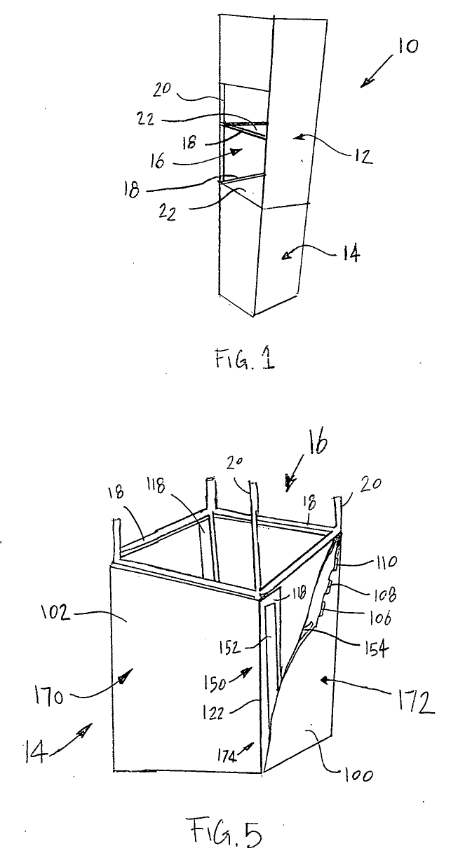

Referring now to the drawings, wherein like numbers refer to like items, number 10 identifies an embodiment of a retail display assembly constructed according to the present disclosure. With reference now to FIG. 1, the retail display assembly 10 comprises an upper portion 12 that is mated to a lower portion 14. The upper portion 12 is adapted to be fitted around an alpha display or display tower 16. The display tower 16 is constructed from various rods 18, poles 20, and shelves 22. Once assembled the display tower 16 forms a merchandise display in which merchandise can be placed on the shelves 22 and displayed on a sales floor. However, in order to attract attention to the plain display tower 16 the retail display assembly 10 is used. Although not depicted in this particular figure, the retail display assembly 10 may have one or more advertisements printed thereon.

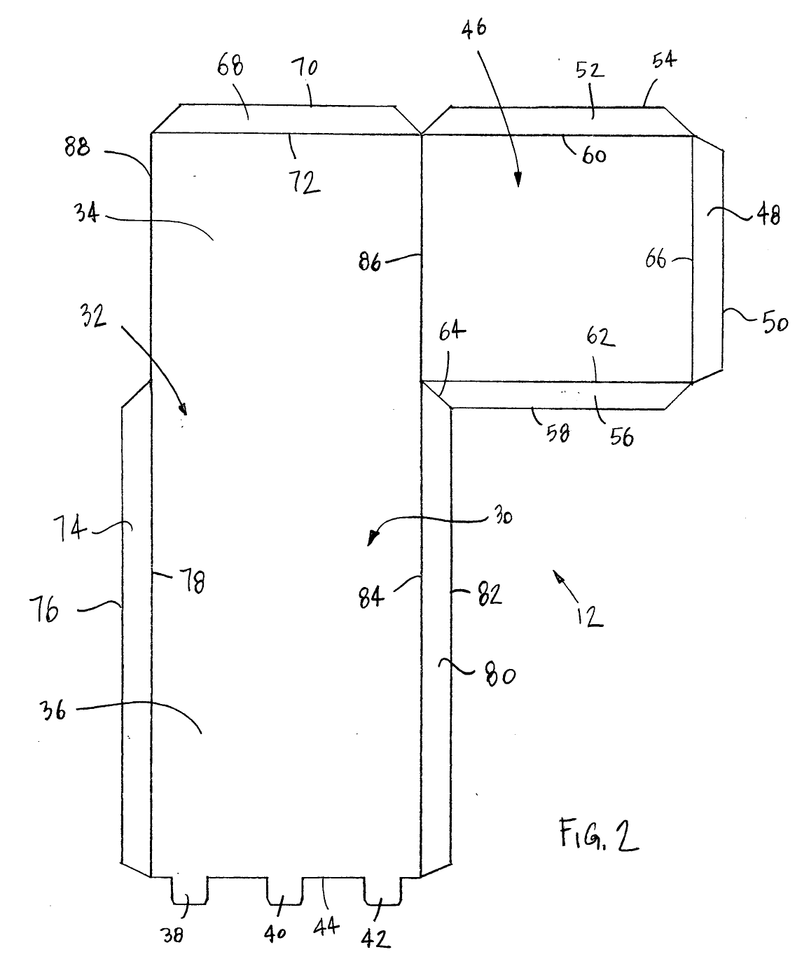

FIG. 2 illustrates the upper portion 12 as a blank 30. The upper portion 12 has a first section 32 having a top portion 34 and a bottom portion 36. The bottom portion 36 has a first tab 38, a second tab 40, and a third tab 42 along a bottom edge 44. Each of the tabs 38, 40, and 42 extend out from the bottom edge 44. A second section 46 extends from the first section 32. The second section 46 has a flap portion 48 along a side 50. The flap portion 48 may be provided with a fastening device, as will be explained more fully herein. The second section 46 also has a top flap 52 extending along a top 54 and a bottom flap 56 extending along a bottom 58. A fold line 60 is formed along the top flap 52 to facilitate folding the flap 52 over onto the backside (not shown) of the upper portion 12. Once folded, the flap 52 may be glued in place. Folding the flap 52 over adds strength and rigidity to the upper portion 12. The bottom flap 56 also has a fold line 62 formed along the length of the flap 56. The fold line 62 allows the flap 56 to be folded over onto the backside. The flap 56 is cut along a cut line 64 to separate the flap 56. A fold line 66 is provided along the flap portion 48. However, the flap portion 48 is not folded over, but is used to fit around a corner of the display 16, as will be discussed in more detail herein.

The first section 32 may also have a flap 68 that extends along a top 70 of the first section 32. A fold line 72 is formed in the first section 32 to facilitate folding the flap 68. The flap 68, once folded, may be glued to a backside (not shown) of the upper portion 12. Again, folding the flap 68 enhances the strength and rigidity of the upper portion 12. The bottom portion 36 may also have a first side flap 74 extending along a left side 76 from the bottom edge 44 up to the beginning of the top portion 34. A fold line 78 is formed in the left side 76 to assist in folding the flap 64 over onto a backside of the upper portion 12. The flap 70 may be glued to a backside of the upper portion 12. The bottom portion 36 may further have a second side flap 80 extending along a right side 82 from the bottom edge 44 up to the beginning of the top portion 34 or the cut line 64. A fold line 84 is provided in the right side 82 to fold over the flap 80. As can be appreciated, the flaps 74 and 80 are used to help strengthen the bottom portion 36. A fold line 86 is formed between the top portion 34 and the second section 46. The fold line 86 is used to fit around a corner of the retail display 16. The top portion 34 also has a left side edge 88. Although not illustrated in this figure, it is possible and contemplated that the first section 32 and the second section 46 may have printed thereon an advertisement.

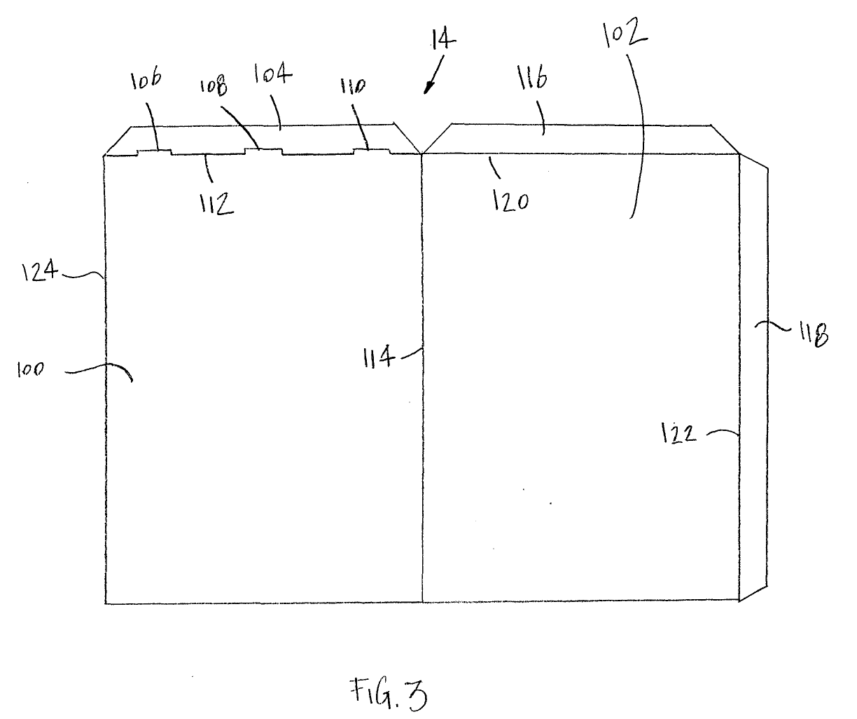

With reference now to FIG. 3, the lower portion 14 of the retail display assembly 10 is shown. The lower portion 14 has a first section 100 and a second section 102. The first section 100 has a top flap 104 having a first slot 106, a second slot 108, and a third 110 formed therein. The slots 106, 108, and 110 are used to receive the tabs 38, 40, and 42 of the upper portion 12. A fold line 112 is formed in the top flap 104 to fold the flap 104 down and adhere the top flap 104 to a backside (not shown) of the first section 100. A fold line 114 is formed between the first section 100 and the second section 102. The fold line 114 allows the lower portion 14 to be placed around a corner of the display 16. The second section 102 has a top flap 116 and a side flap 118. A top fold line 120 is formed in the second section 102 to fold the top flap 116 over. The flap 116, once folded, may be adhered to a backside of the lower portion 14. A side fold line 122 is provided in the second section 102 to be able to fold the flap 118 at a right angle about a corner of the display 16. The first section 100 also has a left side edge 124. The side flap 118 may be provided with a fastening device, as will be discussed in more detail.

FIG. 4 illustrates a fastening device 150 that may be positioned on the flap 48 of the upper portion 12 or the flap 118 of the lower portion 14. In FIG. 4 the fastening device 150 is shown being positioned on the flap 48. The fastening device 150 comprises a strip of a hook fastener 152 and a strip of loop fastener 154. The hook fastener 152 and the loop fastener 154 may be mated together to form a strong bond and are easily separated from each other. The loop fastener 154 also has an adhesive backing 156 that is covered by a strip of clear backing 158. The clear backing 158 protects the adhesive backing 156 until it is to be used. The clear backing 158 is removed when the retail display assembly 10 is being assembled. Although not shown, the strip of hook fastener 152 has an adhesive backing to adhere the hook fastener 152 to the flap 48. Also, as can be appreciated, the orientation of the hook fastener 152 and the loop fastener 154 may be reversed.

Further, in order to assemble the upper portion 12 two upper portions 12 are used. The clear backing 158 is removed to expose the adhesive backing 156 of the fastening device 150 that is positioned on the flap 48. The left edge side 88 of the second upper portion 12 is lined up with the fold line 66 of the first upper portion 12 and then pressed down to adhere the loop fastener 154 to the second upper portion 12. This process is continued with the fastening device 150 that is positioned on the flap 48 of the second upper portion 12. In this manner, a completed upper portion 12 is assembled and placed over or around the display 16. Likewise, in order to assemble the lower portion 14 two lower portions 14 are employed. The clear backing 158 is removed to expose the adhesive backing 156 of the fastening device 150 that is positioned on the flap 118. The left edge side 124 of the second lower portion 14 is aligned with the fold line 122 of the first lower portion 14 and then pressed down to adhere the loop fastener 154 to the second lower portion 14. This process is continued with the fastening device 150 that is positioned on the flap 188 of the second lower portion 14 and the lower portion 14 is completed.

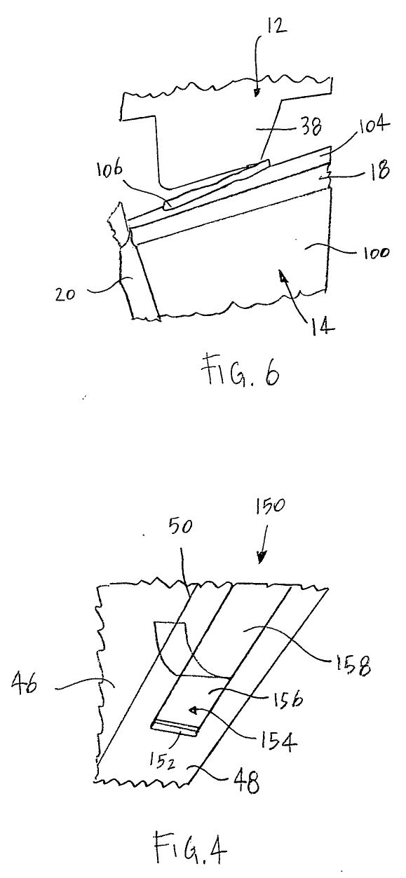

Turning now to FIG. 5, an illustration of how the lower portion 14 is assembled around the display 16 is depicted. In order to fully cover the display 16 a pair the lower portions 170 and 172 are used. In particular, the fastening device 150 is used to attach the lower portion 172 to the lower portion 170 to hold the completed lower portion 14 in place around the rods 18 and poles 20 of the display 16. The fold line 122 is shown being positioned around a pole 20 to form a corner 174 of the display 16. The loop fastener 154 is pressed against the hook fastener 152 to hold the two lower portions 170 and 172 in place. In order to remove the completed lower portion 14 the loop fastener 154 is released from the hook fastener 152.

With particular reference now to FIG. 6, there is shown an upper portion 12 being mated to a lower portion 14 by use of the tab 38 being inserted into the slot 106. The tab 38 aligns the upper portion 12 with the lower portion 14. In this manner, any advertisement printed on the upper portion 12 and the lower portion 14 is aligned and may appear seamless to a customer.

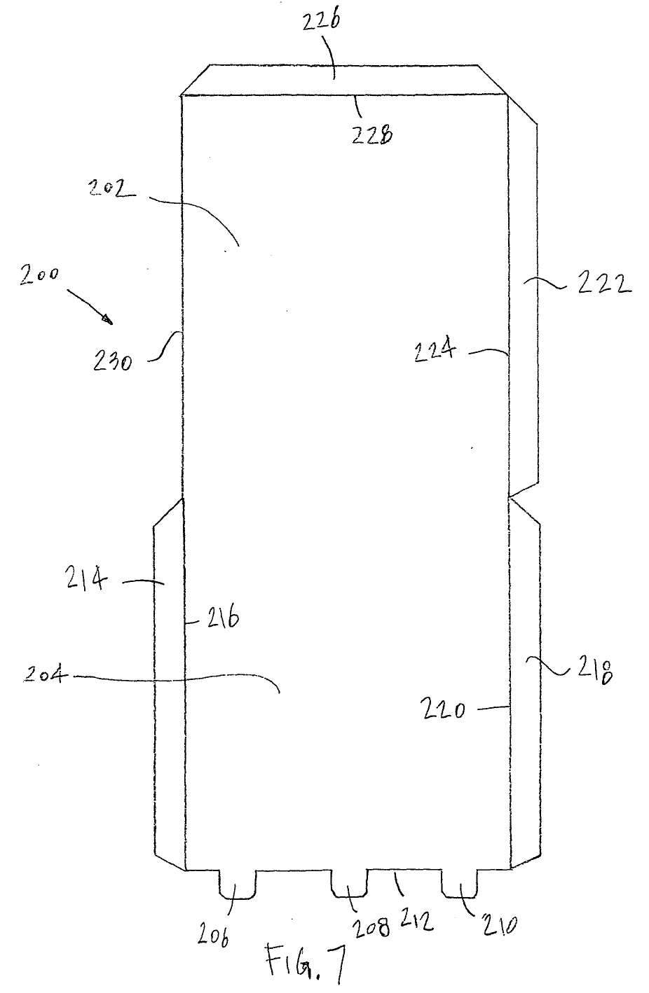

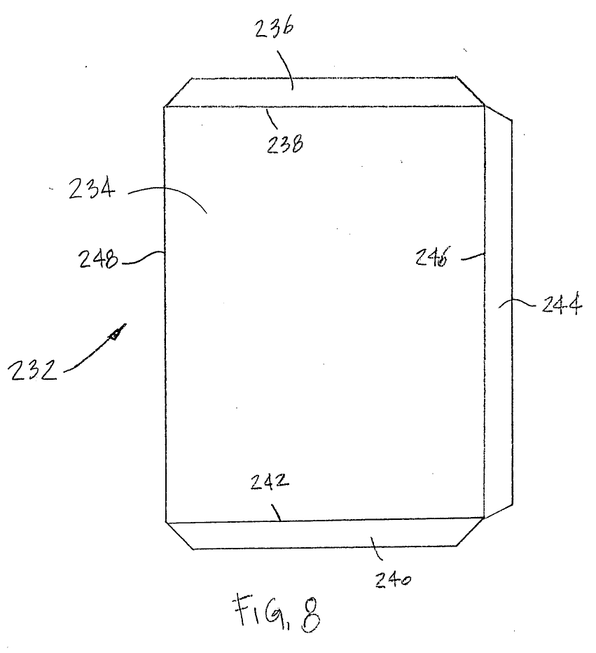

FIG. 7 depicts another embodiment of a left side upper portion 200 constructed according to the present disclosure. The upper portion 200 comprises a top portion 202 and a bottom portion 204. The bottom portion 204 has a first tab 206, a second tab 208, and a third tab 210 along a bottom edge 212. Each of the tabs 206, 208, and 210 extend out from the bottom edge 212. The bottom portion 204 has a left side flap 214 and a fold line 216. The left side flap 214 may be folded over at the fold line 216 and adhered to the backside (not shown) of the bottom portion 204. As has been discussed previously, folding the flap 214 over adds strength to the upper portion 200. The portion 204 further has a right side flap 218 and a fold line 220. The top portion 202 has a flap 222 and a fold line 224. The flap 222 may be provided with a fastening device 150. The flap 222 is not folder over and the fold line 224 is positioned around a corner of the display 16. The top portion 202 also has a top flap 226 and a fold line 228. The top flap 226 is folded over and glued to the backside (not shown) of the top portion 202. The left side upper portion 200 also has a left side edge 230.

Referring now to FIG. 8, a right side upper portion 232 is shown. The right side upper portion 232 comprises a portion 234 having a top flap 236, a top fold line 238, a bottom flap 240, a bottom fold line 242, a side flap 244, a side flap fold line 246, and a left side edge 248. The top flap 236 and the bottom flap 240 are folded over and glued to the backside (not shown) of the right side upper portion 232. The side flap 244 may be provided with a fastening device 150. Attaching the left side upper portion 200 to the right side upper portion 232 forms an upper portion 12 that may be used with another pair of portions 200 and 232 to be assembled on a display 16. The left side upper portion 200 and the right side upper portion 232 may have advertisements printed thereon. In this particular embodiment it is possible to print different advertisements on the right side upper portions 232 to present varying ads to a customer. In this manner various ads may be mixed and matched. In order to complete the retail display assembly 10 the tabs 206, 208, and 210 are mated with the slots 106, 108, and 110 of a lower portion 14.

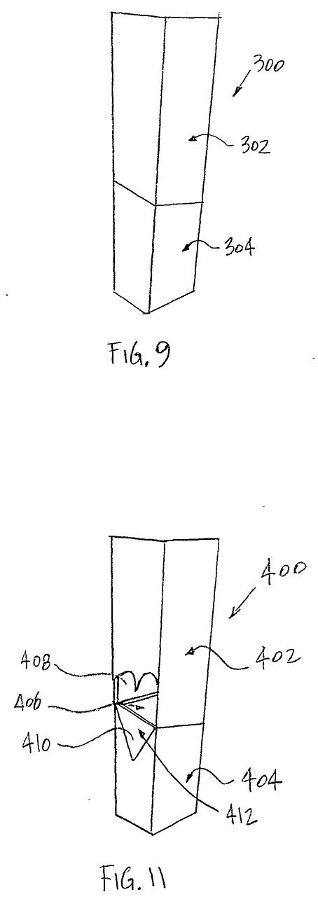

FIG. 9 depicts another embodiment of a retail display assembly 300. The retail display assembly 300 comprises an upper portion 302 that is mated to a lower portion 304. The upper and lower portions 302 and 304 are adapted to be fitted around an alpha display or display tower such as alpha display 16. In this particular view the alpha display 16 is completely covered by the retail display assembly 300 and no ready access to the alpha display 16 is provided. As can be appreciated from previous discussions, the retail display assembly 300 may have one or more advertisements printed thereon, however such is not illustrated in FIG. 9. In particular, the retail display assembly 300 is used as a display device that does not allow a customer to access any products stored within the retail display assembly 300. For example, excess products or supplies may be stored in the retail display assembly 300 for retrieval by store personnel only. In this manner the store personnel need not go back to the storage room to obtain product this is being sold.

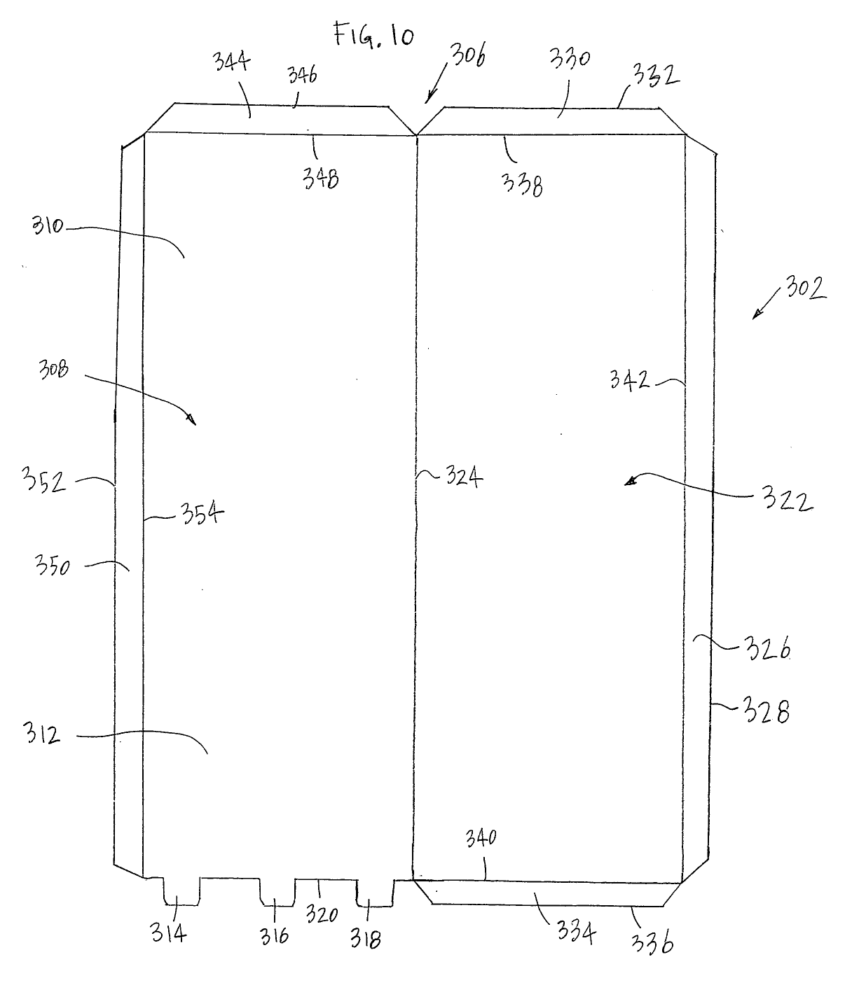

With particular reference to FIG. 10 the upper portion 302 is shown as a blank 306. The upper portion 302 has a first section 308 having a top portion 310 and a bottom portion 312. The bottom portion 312 has a first tab 314, a second tab 316, and a third tab 318 along a bottom edge 320. Each of the tabs 314, 316, and 318 extend out from the bottom edge 320. A second section 322 is provided next to the first section 308 along a fold line 324. The fold line 324 is used to fit around a corner of the retail display 16. The second section 322 has a flap portion 326 along a side 328. The flap portion 326 may be provided with a fastening device, such as the fastening device 150 illustrated in FIG. 4. The second section 322 also has a top flap 330 extending along a top 332 and a bottom flap 334 extending along a bottom 336. A fold line 338 is formed along the top flap 330 to facilitate folding the top flap 330 over onto the backside (not shown) of the second section 322. Once folded, the top flap 330 may be glued in place. Folding the top flap 330 over adds strength and rigidity to the second section 322. The bottom flap 334 also has a fold line 340 formed along the length of the bottom flap 334. The fold line 340 allows the bottom flap 334 to be folded over onto the backside. A fold line 342 is provided along the flap portion 326. However, the flap portion 326 is not folded over, but is used to fit around a corner of the display 16, as will be discussed in more detail herein.

The first section 308 may also have a top flap 344 that extends along a top 346 of the first section 308. A fold line 348 is formed in the first section 308 to facilitate folding the top flap 344. The top flap 344, once folded, may be glued to a backside (not shown) of the upper portion 310. Again, folding the top flap 344 enhances the strength and rigidity of the upper portion 310. The first section 310 may also have a side flap 350 extending along a side 352 from the bottom edge 320 up to the fold line 348. A fold line 354 is formed in the side 352 to assist in folding the side flap 350 over onto a backside of the first section 308. The side flap 350 may be glued to a backside of the first section 308. Again, although not illustrated in this figure, it is possible and contemplated that the first section 308 and the second section 322 may have printed thereon an advertisement, other graphic illustrations, or art. An example of the lower portion 304 that can be mated or fitted to the upper portion 302 is the lower portion 14 as shown in FIG. 3.

In order to assemble the retail display assembly 300 two upper portions 302 are connected together by using the fastening device 150 on each of the flap portion 326. Once the upper portions 302 are connected together the completed upper portion 302 is placed over or around the display 16. Likewise, in order to assemble the lower portion 14 two lower portions 14 are connected together as has been previously described. The lower portion is also placed over or around the display 16. Also the tabs 314, 316, and 318 are inserted into slots associated with the lower portion 14. This completes the retail display assembly 300 with the retail display assembly 300 also fully covering the display 16.

FIG. 11 illustrates another embodiment of a retail display assembly 400. The retail display assembly 400 comprises an upper portion 402 that is mated to a lower portion 404. The upper and lower portions 402 and 404 are adapted to be fitted around an alpha display or display tower 406. The upper portion 402 has a cutout portion 408 and the lower portion 404 has a cutout portion 410 that form a shape 412 such as a heart. Although it is possible and contemplated that any shape or pattern may be formed in the upper portion 402 or lower portion 404. For example, the upper portion 402 may include the shape 412 and the lower portion 404 may not include the shape 412, or vice versa. It is also possible that only a front side of the retail display assembly 400 may have the shape 412 formed therein and the a back side may not have the shape 412 formed therein.

It should be recognized that the retail display assemblies 10, 300, or 400 of the present disclosure could be constructed of various materials such as paper, cardboard, foam board, plastic, metal, or wood veneer. Preferably, the assemblies 10, 300, or 400 will be formed of relatively lightweight material so that the assemblies 10, 300, or 400 can be easily manufactured, assembled, positioned, secured in place, removed, transported, and stored. Further, the assemblies 10, 300, or 400 can be constructed of relatively inexpensive materials that will provide for the assemblies 10, 300, or 400 to be mass produced, disposable, and suitable for one time use. It is also possible that the retail display assemblies 10, 300, or 400 can be assembled to be placed around a display 16 of various shapes or configurations. For example, if a six-sided display is being used then three upper portions 12 and three lower portions 14 will be needed to cover a six-sided display.

From all that has been said, it will be clear that there has thus been shown and described herein a retail display assembly which fulfills the various objects and advantages sought therefor. It will become apparent to those skilled in the art, however, that many changes, modifications, variations, and other uses and applications of the subject retail display assembly are possible and contemplated. All changes, modifications, variations, and other uses and applications which do not depart from the spirit and scope of the present disclosure are deemed to be covered by the present disclosure, which is limited only by the claims which follow.

What is claimed is:

1. A retail display assembly adapted to be placed on a display tower comprising:
an upper portion having a first section having a top portion and a bottom portion with the bottom portion having a tab portion extending from the bottom portion and a second section having a top portion and a side flap; and
a lower portion having a first section having a top portion having a slot adapted for receiving the tab portion and a second section having a side flap.

2. The retail display assembly of claim 1 wherein the bottom portion further comprises a second tab portion and the first section of the lower portion having a second slot adapted for receiving the second tab portion.

3. The retail display assembly of claim 2 wherein the bottom portion further comprises a third tab portion and the first section of the lower portion having a third slot adapted for receiving the third tab portion.

4. The retail display assembly of claim 1 wherein the side flap of the second section of the upper portion comprises a hook fastener portion and a loop fastener portion.

5. The retail display assembly of claim 1 wherein the upper portion has a cutout portion forming a shape.

6. The retail display assembly of claim 1 wherein the upper portion further comprises a first side having an advertisement printed thereon.

7. The retail display assembly of claim 1 wherein the upper portion has a first advertisement portion printed thereon and the lower portion has a second advertisement portion printed thereon and the first advertisement portion and the second advertisement portion forming a contiguous advertisement.

8. A retail display assembly adapted to be placed on a display tower comprising:
a pair of upper portions with each upper portion having a first section having a top portion and a bottom portion with the bottom portion having a tab portion extending from the bottom portion and a second section having a top portion and a side flap; and
a pair of lower portions with each lower portion having a first section having a top portion having a slot adapted for receiving the tab portion and a second section having a side flap.

9. The retail display assembly of claim 8 wherein each of the bottom portions further comprises a second tab portion and each of the first sections of the lower portions has a second slot adapted for receiving the second tab portion.

10. The retail display assembly of claim 9 wherein each of the bottom portions further comprises a third tab portion and each of the first sections of the lower portions has a third slot adapted for receiving the third tab portion.

11. The retail display assembly of claim 8 wherein each of the side flaps of the second section of the upper portions comprises a hook fastener portion and a loop fastener portion.

12. The retail display assembly of claim 8 wherein each of the side flaps of the second section of the lower portions comprises a hook fastener portion and a loop fastener portion.

13. The retail display assembly of claim 8 wherein each of the upper portions further comprises a first side having an advertisement printed thereon.

14. The retail display assembly of claim 8 wherein each of the upper portions has a first advertisement portion printed thereon and each of the lower portions has a second advertisement portion printed thereon and the first advertisement portion and the second advertisement portion forming a contiguous advertisement.

15. A retail display assembly adapted to be placed on a display tower comprising:
a left side upper portion having a first section having a top portion, a bottom portion with the bottom portion having a tab portion extending from the bottom portion, and a side flap, and a right side upper portion having a side flap; and
a lower portion having a first section having a top portion having a slot adapted for receiving the tab portion and a second section having a side flap.

16. The retail display assembly of claim 15 wherein the bottom portion further comprises a second tab portion and the first section of the lower portion having a second slot adapted for receiving the second tab portion.

17. The retail display assembly of claim 15 wherein the bottom portion further comprises a third tab portion and the first section of the lower portion having a third slot adapted for receiving the second tab portion.

18. The retail display assembly of claim 15 wherein the right side upper portion further comprises a top flap, a top fold line, a bottom flap, and a bottom fold line.

19. The retail display assembly of claim 15 wherein the side flap of the first section of the left side upper portion comprises a hook fastener portion and a loop fastener portion.

20. The retail display assembly of claim 15 wherein the side flap of the right side upper portion comprises a hook fastener portion and a loop fastener portion.
